(19) United States
(12) Patent Application Publication
(10) Pub. No.: US 2007/0177788 A1
(43) Pub. Date: Aug. 2, 2007

(54) System and method for detecting wafer failure in wet bench applications

(76) Inventor: David Liu, Hsinchu City (TW)

Correspondence Address: DUANE MORRIS LLP;IP DEPARTMENT (TSMC), 30 SOUTH 17TH STREET, PHILADELPHIA, PA, 19103-4196, US

(21) Appl. No.: 11/344,032

(22) Filed: Jan. 31, 2006

(51) Int. Cl. G06K 9/00

(52) U.S. Cl. 382/145

(57) ABSTRACT

A system is disclosed for detecting the presence of a broken or mis-positioned wafer during bench processing of the wafers. In one embodiment, a charge-coupled device (CCD) is provided above a wet bench bath, and is positioned to record an image of the bath and its contents. The CCD is connected to processing software that compares the image with a stored image of the bath. Based on the image comparison, the system can provide either a “go” indication, where the images are deemed substantially the same, or an “error” indication, where the images are deemed substantially different thus indicating the presence of broken wafer pieces in the bath. In a second embodiment, the CCD may be positioned to record an image of a plurality of wafers carried on a cassette-less wafer lifter held above the bath. Again, the CCD may be connected to processing software that compares the image with a stored image of the plurality of wafers on the lifter. Based on the image comparison, the system can provide a “go” indication if the images are substantially the same, or an “error” indication if the images are substantially different—indicating the presence of a broken or mis-positioned wafer on the wafer lifter. A method of using the system is also disclosed.

### FIELD OF THE INVENTION

The present invention relates to a method and apparatus for detecting the presence of broken or otherwise mispositioned semiconductor wafers in a cassette-less wet bench apparatus.

### BACKGROUND OF THE INVENTION

The process of semiconductor manufacturing involves a wide variety of steps including a layer formation process for forming multiple layers such as polycrystalline, oxide, nitride layer, metal, etc., on a wafer as a semiconductor substrate. These steps generally also include a diffusion process, a photolightography process, an etching process, a cleaning process, etc., which are carried out between the steps of layer formation.

Etching is a process in which selected material is removed from a silicon substrate or from thin films on the substrate surface. In one type of selective etching, a mask layer is used to protect specific regions of a substrate on a wafer surface, then a selective etch removes material not covered by the mask. Etching can be performed through two methods, one is dry etching using gas, while another is wet etching using wet chemical. Plasma etching, ion beam etching and reactive ion etching are included in the former, while immersion etching and spray etching are included in the latter.

A common device for wet chemical etching of semiconductor wafers is an immersion chemical cleaning device, also called a wet bench, which includes a plurality of chemical tanks, cleaning tanks, robots, and driers. Batches of wafers are moved in sequence through the tanks, typically by operation of a computer-controlled automated apparatus. Currently, semiconductor manufacturers use wet cleaning processes which may use cleaning agents such as deionized water (DIW) and/or surfactants. Other wafer-cleaning processes utilize solvents, dry cleaning using high-velocity gas jets, and a megasonic cleaning process, in which high-frequency sound waves are used to dislodge particles from the wafer surface.

During wafer transfer, it is possible for the carried wafers to change in position on the wafer lifter, or even for portions of the wafer to break off, due to inaccuracies in the transfer robot positioning, damaged holding mechanisms in the process chamber, etc. It is important that broken or mispositioned wafers be identified quickly in order to minimize the chance that such wafers may cause serious damage to the wafer lifting chuck, the wafer guide, or the process tank itself. Additionally, broken wafer pieces, depending on their positioning, can scrape all of the wafers that pass by them, resulting in large scale waste.

As shown in FIGS. 1a-d, present detection designs used with DIW baths employ photo sensors to detect the presence of wafer pieces 1000 remaining in the bath after the wafers have been removed. A laser is positioned to beam through the DIW bath, and if the photo sensor receives the beam then the system assumes that there are no wafer pieces 1000 remaining in the bath. The problem with such systems is that it is possible for broken wafer pieces to fall under the beam of the detecting laser where they can remain undetected, causing damage to system equipment. Additionally, the system is unable to detect other potentially damaging wafer abnormalities, such as may occur when a broken or mispositioned wafer is held between adjacent wafers so that it does not fall into the bath. Such broken wafers can still cause damage to the wafer chuck and wafer guide as previously described. Furthermore, the current photo sensor arrangements can only practically be installed on DIW baths, and can not be used with chemical baths due to corrosion caused by overflow of chemical, and/or due to the opaque nature of the process tank wall which make transmission of the laser beam impossible.

Thus, there is a need for a system that can reliably detect broken wafer conditions in a variety of wet bench tank applications, including both DIW baths and corrosive and/or opaque chemical baths. Such a system should be able to detect broken wafer pieces lodged in the bottom of the bath, as well as mispositioned or broken wafers held between adjacent wafers on a lifter.

### SUMMARY OF THE INVENTION

A system for detecting a wafer in a process tank is disclosed. The system may comprise a process tank and an image detection device positioned adjacent said process tank. The imaging device may be configured to obtain a first set of image data representing an internal portion of said process tank. The system may further comprise an image processing device connected to said image detection device for receiving said first set of image data from said image detection device. Wherein said image processing device may be capable of comparing said first set of image data to said first set of stored data to indicate the presence of a first conforming condition when the difference between the first set of image data and the first set of stored data is within a first predetermined range, and to indicate the presence of a first nonconforming condition when the difference between the first set of image data and the first set of stored data is outside said first predetermined range.

A system is further disclosed for detecting a wafer. The system may comprise an image detection device for receiving a first image of an internal portion of a semiconductor process tank. The imaging device may further be configured to transmit a first set of image data representing said internal portion of said semiconductor process tank. The system may further comprise an image processing device connected to said image detection device for receiving said first set of image data from said image detection device. Wherein said image processing device may be capable of comparing said first set of image data with said first set of stored data to indicate the presence of a first conforming condition when the first set of image data substantially conforms to said first set of stored data, and to indicate the presence of a first nonconforming condition when the image data does not substantially conform to said first set of stored data.

A method is also disclosed for detecting a semiconductor wafer, comprising: receiving a first image representing an internal portion of a semiconductor process tank; digitizing said first image and providing a first signal to an image analyzer, said first signal comprising a first set of data representative of said first image; displaying said first image on a display device for viewing by an operator; comparing said first set of data to a first set of stored data to obtain a first difference between said first set of data and said first set of stored data, wherein said first set of stored data represents a conforming condition of said semiconductor process tank; and sending a second signal when said first difference is not within a first predetermined range, thus representing a non-conforming condition of said semiconductor process tank; wherein said second signal comprises an alarm signal for communicating said non-conforming condition to said operator.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts, and further wherein:

FIGS. 1a-d are side views of a traditional system for detecting semiconductor wafers in a wafer process tank;

FIG. 2 is an isometric view of the inventive system incorporating an image sensing device located above a wafer process tank;

FIG. 3 is an isometric view of an embodiment of the inventive system incorporating an automate image comparison feature;

FIG. 4 is a side view of an alternative embodiment of the inventive system incorporating a sonar transmitter and detector for monitoring the wafer process tank of FIG. 2;

FIG. 5 is a side view of a further alternative embodiment of the inventive system incorporating an infrared transmitter and receiver for monitoring the wafer process tank of FIG. 2;

FIG. 6 is an isometric view of an additional alternative embodiment of the inventive system incorporating a movable detection device for monitoring the wafer process tank;

FIG. 7 is an isometric view of a further alternative embodiment of the inventive system in which at least one wafer in the tank is movable in relation to the detection device.

### DETAILED DESCRIPTION

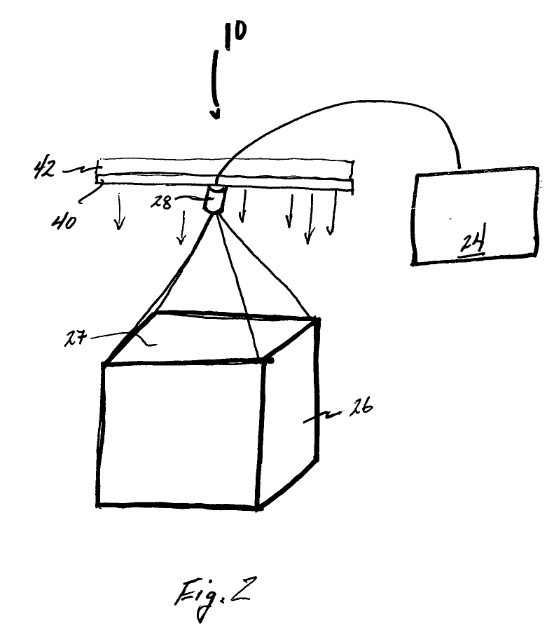

According to an embodiment of the present invention, disclosed herein is a process inspection system 10 for use in detecting broken or mispositioned wafer conditions during a variety of wet bench processes. Referring to FIG. 2, the process inspection system 10 may comprise an image detection device 28 positioned at a desired location over a wafer process tank 26. In an exemplary embodiment, the image detection device 28 is a charge-coupled device (CCD) camera, and the wafer process tank 26 is a DIW tank of a wet bench. However, where the process tank contains corrosive fluid, such as phosphoric acid (H₃P0₄), the system 100 may further comprise a source of high efficiency particulate air (HEPA) oriented to flow down over the detection device 28 to protect it from corrosive chemical fumes which may emanate from the process tank being monitored. Thus, a HEPA filter 40 and air supply 42 may be provided above or in an appropriate location adjacent the detection device 28.

The image detection device 28 may be configured to receive an image of the entire top surface 27 of the process liquid contained in the wafer process tank 26. Of course, where the process liquid is not opaque, the image detection device 28 will also receive an image of the contents of the process tank (e.g. the wafers 1000, wafer lifter, etc.). The image detection device 28 may be electrically connected to a processing system 24 which houses image processing circuitry and software for converting signals generated by the image detection device 28 into an image suitable for viewing by a user. The resulting image may then be displayed on a viewing device such as a computer monitor located at, for example, and operator work station. The operator may view the image to make a quick determination of whether the tank conditions are acceptable or not acceptable. One example of a non-conforming, or unacceptable, condition would be the presence of broken wafer pieces 1000 in the process tank, or of mispositioned wafers 1000 on the wafer lifter. Both conditions should be readily determinable by a remote operator viewing the image of the tank and its contents using the image detection device 28. The detection device 28 may be operated to take “still” shots upon receiving a command from the operator, or it may be operated continuously to take “video” of the process operation.

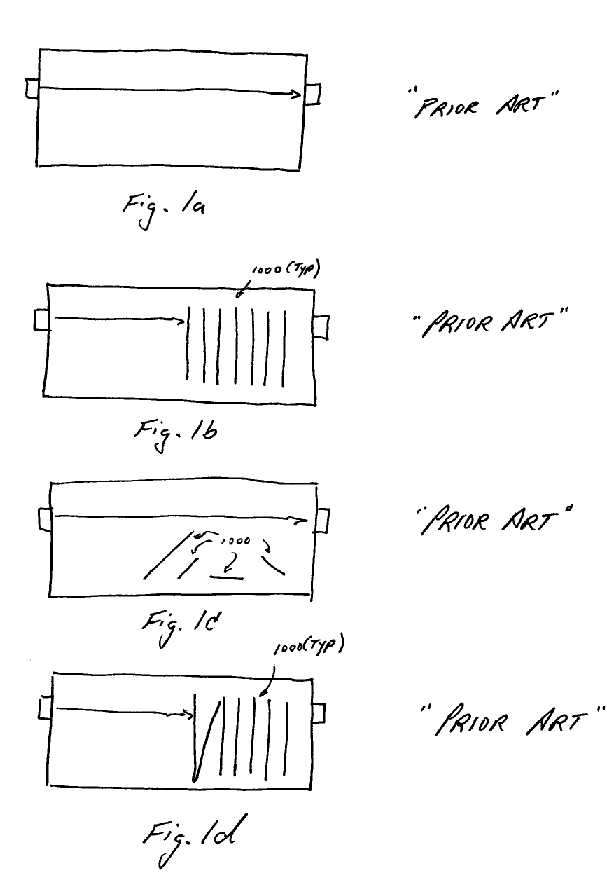

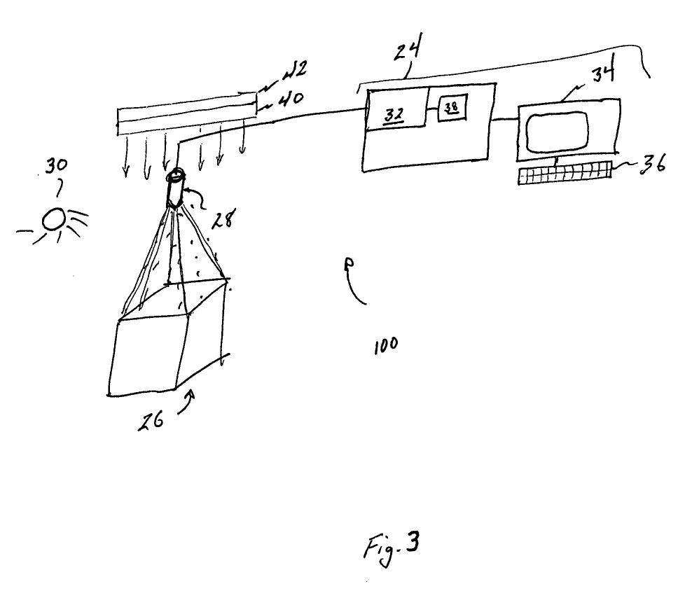

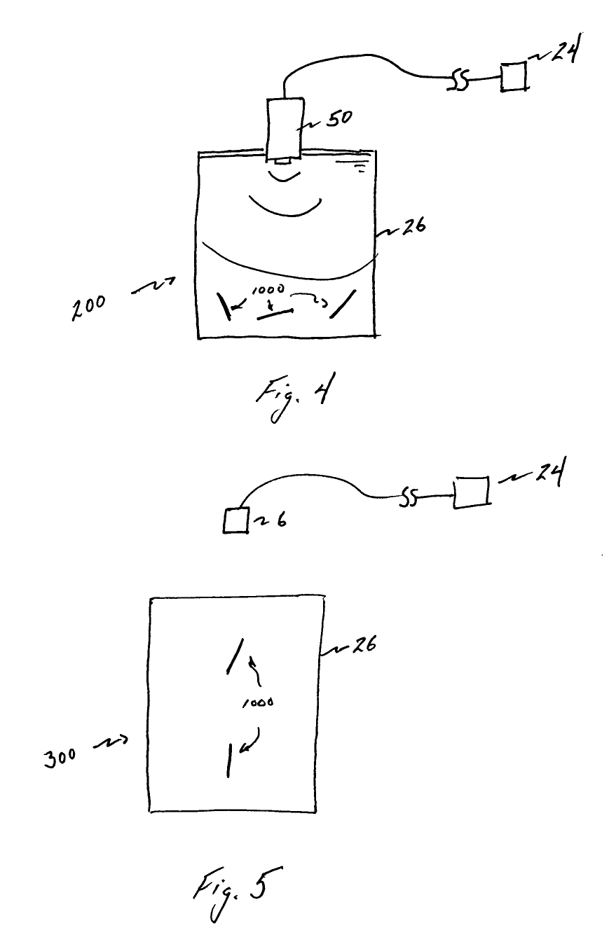

Referring to FIG. 3, process inspection system 100 may be a fully automated inspection system comprising suitable software for performing automated comparison of an image of the process tank 26 and/or the contents of the tank with a predetermined “conforming condition” or “acceptable condition” image configuration to automatically determine if the conditions in the tank are conforming, or if a non-conforming condition exists. The process inspection system 100 may comprise components similar to those described above in relation to FIG. 1. Thus, the inspection system 100 may comprise an image detection device 28 connected to an image analyzer 24. The detection device 28 may be used within the system to receive and digitize an image of a targeted portion of the process tank 26, or a portion of the contents of the process tank, and may provide a detection signal to analyzer 24. The detection signal may be a digitized image of a targeted portion of the process tank and/or a structure within the process tank, such as a wafer lifter. The analyzer 24 may receive the detection signal and may then use the signal to perform various analytical tasks, such as using the signal to compare the received image with a previously-stored image representing a conforming condition in the tank. For example, an image of an empty process tank may be used as a “background pattern” representing the conforming condition in the tank. Thereafter, an image of the process tank may be received by the detection device 28 after a batch of wafers 1000 have been transferred out of the process tank. This image may be digitized and sent to the image analyzer 24, which may then compare the two digitized images. Any substantial disparity between the images may represent a non-conforming condition in the process tank, such as materials (broken wafer pieces) remaining in the tank. In another example, the space normally taken up in the process tank by the wafers 1000 and lifter can be “shadowed” using appropriate software. Thereafter, an image of the process tank can be received by the detection device 28 after the wafers 1000 are transferred into the tank. The presence of any substantial material in the “non-shadow” area may represent an abnormality (e.g. broken wafer, position-shifted wafer, or other obstruction).

The image analyzer 24 may be configured to perform a variety of additional or alternative analytical tasks, such as analysis of the signal, statistics processing, task scheduling, generation of alarm signals, generation of further control signals, and the like. The analyzer 24 may be placed adjacent process tank 26 so that the operator may have quick and easy access to both the analyzer 24 and the process tank 26, to determine the non-conforming condition and to attend to and to correct the cause of the condition. Alternatively, the analyzer 24 may be placed at a remote location such as a process command center where a variety of images from a variety of processing stations or wet benches can be monitored together.

In one embodiment, the detecting device 28 (or analyzer 24) may also store an image of the inspected area for future use and analysis. As previously noted, the detecting device 28 may comprise a CCD camera, a photocell, or other such automated detecting apparatus which generates or creates an image of an area presented thereto. In one embodiment, the detecting device 28 includes at least one CCD monochrome or color camera, depending on the process being inspected, as described in further detail below. The use of a CCD camera advantageously permits generation of electrical signals that are readily transferred and processed by the analyzer 24. Thus, the detection device 28 may supply a high resolution image to the analyzer 24.

In order to maximize the quality of the image obtained by the detector 28, an illumination device 30 may be provided to ensure a desired amount of light is available in the inspection area. In one embodiment, the illumination device may comprise a lighting system which alters the lighting conditions so that visual features of the inspection area can be adequately detected by the detecting device 28. The type and design of the illumination device 30 may depend on the type of detector 28 used, but in general, the illumination device may create a diffuse, uniform illumination of the targeted inspection area so that a high quality image of the inspection area may be readily detected by the detecting device 28 and appropriately analyzed by analyzer 24. In one embodiment, the illumination device 30 may comprise flood lighting that provides uniform light reflection on the objects in the targeted inspection area, and which eliminating glare, shading, and image distortion. Alternatively, the illumination device 30 may comprise a plurality of light-emitting diodes (LEDs).

As previously noted, the detecting device 28 may transmit a digitized version of a received image to the image analyzer 24. The image analyzer 24 may include a computer processor 32, and a monitor 34, or other display. A user interface 36 (e.g., keyboard, mouse or touch sensitive area on the monitor) may also be provided to enable the user to interface with the processor 32. As previously noted, the processor 32 may analyze the image provided from the detecting device 28 to determine whether a conforming condition exists within the tank (e.g. whether a wafer is mispositioned on the wafer lifer, or whether broken pieces of wafer remain within the process tank 26 after the wafers 1000 have been removed). Analysis of this kind may involves a comparison of the detected image with a reference image stored in a memory element 38 associated with the processor 32. Simultaneous to the analytic operations of the processor 32, the image itself may be displayed on the monitor 34 so that an operator may view the results of the inspection analysis. This may be of particular advantage where a non-conforming condition is detected, allowing the operator to confirm the condition of the process tank.

Thusly arranged, the image analyzer 24 may be used to monitor the conditions within the process tank 26. In one embodiment, the image analyzer 24 also may be equipped to emit a signal or an alarm to notify the operator of a non-conforming condition within the tank. For example, an appropriate audible or visual alarm may be used to alert the operator of a non-conforming condition so that the operator can visually confirm the condition by viewing the image on the monitor (or even by inspecting the tank itself). In one embodiment, the image analyzer 24 may comprise a speaker and/or a light-emitting diode (LED), liquid crystal display (LCD) or other visual indicator that may function as an alarm, providing an error signal to alert a user that a non-conforming condition exists in the associated process tank 26. The analyzer 24 also may generate a signal directly or indirectly to the process equipment that stops further movement of the associated wafer lifter and/or prevents a new batch of wafers 1000 from being lowered into the process tank 26 until the non-conforming condition is rectified. Automatically stopping movement of the apparatus is advantageous because it can prevent damage to the lifter and/or new wafers 1000 due to contact with broken wafer pieces remaining in the process tank.

The analyzer 24 may comprise memory for short or long term storage of data representing the image in a memory element 38 associated with the processor 32. It will be appreciated that this memory element 38 can be permanent or removable, such as RAM, flash memory, magnetic disc, magnetic tape, optical disc, etc.

The data received by and generated by the image analyzer 24 may be used to generate reports illustrating the results of the overall wafer production process and/or of individual processes. For example, data representing the conditions within the monitored process tanks can be correlated with other process data to better understand the causes of non-conforming conditions in the tank. Thus, for example, it might be determined that a specific upstream process, when run out of tolerance, positively correlates with an increase in broken wafers 1000 in the DIW tank. Such information can be used to refine the overall production process by either refining individual processes, or by better educating and/or training of the process operators, or both.

It will be appreciated that the automated inspection system 100 may be installed to monitor a plurality of process tanks 26 associated with a single wet bench comprising a plurality of individual process tanks. One or more detecting devices 28 may be associated with each process tank of a wet bench, or with only selected process tanks. Each detecting device 28 may comprise optics or at least one camera capable of acquiring or generating an image with sufficient speed so as not to interfere with process occurring in the process tank 26. Preferably, the field of view is digitized to about 512×480 or higher pixel video image or any other image permitting sufficient resolution for effective analysis. A still image of the targeted inspection area may also be generated and maintained in memory, removable media, or hard copy.

As previously noted, the detecting device 28 may receive an image of the targeted inspection area and transfer a signal representing the image to the image analyzer 24 to determine a condition of the process tank 26. In one embodiment, the processor 32 employs one or more analysis algorithms to analyze a variety of aspects of the image transmitted thereto to determine whether the image conforms with the characteristics of a reference image template. The algorithms performed by processor 32 may simply compare the individual pixels of each image to identify non-identicality between the two. Other possible algorithms include an image correlation or alignment algorithm, sequential similarity algorithm, a discrete element detection algorithm, an element boundary detection and characterization algorithm, and/or a thickness measurement algorithm. Several or all such algorithms, as well as or alternatively other algorithms may be used. However, a combination of algorithms generally results in a more accurate inspection than achievable by separate use of any one algorithm.

In one embodiment of image analyzer 24, the processor 32 may compare the inputted image information against reference image information stored in memory 38 in order to detect the occurrence of an abnormality. Reference images may be images of non-defective conditions, registered beforehand as templates, and these may be compared against the input image information using an appropriate algorithm as noted above.

In one example, the image analyzer 24 may convert the first image data into a first set of calculated dimensions (e.g. distance between adjacent wafers 1000 on a wafer lifter) and may then compare the first set of calculated dimensions with a first set of preset dimensions so as to generate a first signal when the first set of calculated dimensions conforms with the first set of predetermined dimensions to indicate presence of a conforming condition in the process tank 26. The analyzer 24 may generate a second signal when the first set of calculated dimensions does not conform with the first set of predetermined dimensions.

Thus, the combination of signal processing and image analysis performed on the detected images permit may allow accurate inspection which reduces or eliminates the need for human intervention during processing, absent the indication of a non-conforming condition.

Where the process inspection system 100 is used to monitor a plurality of different process tanks within one or more wet benches, the system may be adapted to receive data from the plurality of detecting devices 28, and to process the data using processor 32 by applying one or more of the same or different algorithms for detection device 28, to determine whether conforming or non-conforming conditions exist within each tank. The results of the analyses may be displayed via one or more monitors 34 for review by the operator.

FIG. 4 shows process inspection system 200 incorporating a sonar transducer 50 as a source of image data instead of the detection device 28 (e.g. CCD camera) described above in relation to FIGS. 2-3. The active sonar transducer 50 is used to transmit and receive sonar waves within the process tank 26 for monitoring a condition of the tank. Unlike the detection device 28 of FIGS. 2-3, which may be positioned above the process tank, the sonar transducer must be placed in contact with the process tank fluid in order for the sonar pulse to be transmitted to the fluid. Thus, where the process fluid in the tank is DIW, the transducer 50 may be placed in direct contact with the fluid. Where the process fluid in the tank is corrosive (e.g., H₃PO₄), the transducer may be covered or coated with a protective material, or it may be made with an anticorrosive material. (e.g., fluoropolymer (PFA)) or installed in a container with a protective encapsulant fluid. Because to sonar pulse has to go through the wall of container in order to detect broken wafer, the thickness of wall and the distance from the wall to the emitter are also taken into consideration. Minimizing the intensity of reflected wave due to the container's wall can also minimize interference noise. And, the reflect time can be calculated to identify whether the noise is due to the wall or to a real obstruction.

Similar to the image detection system described in relation to FIGS. 2 and 3, a baseline reflected sound profile may be stored in the memory 38 of the image analyzer 24. During operation, the sonar transducer 50 can be used to emit and receive sonar waves within the process tank 26, such as immediately after processing has been completed on a set of wafers 1000 and the wafers have been removed from the process tank 26. The echoed signals maybe transmitted to the image analyzer 24 where they may be compared to the baseline reflected sound profile. Where substantial differences are detected between the received signals and the baseline reflected sound profile, such may indicate a non-conforming condition in the process tank 26. Process inspection system 200 may incorporate some or all of the elements and features of the system 100 described in relation to FIGS. 2 and 3, including user interfaces, analysis software, alarms, as desired.

In order to provide a sonar scan of the entire process tank 26 and its contents, the active sonar transducer may be coupled to one or more translation devices 80, 82 configured to move the transducer 50 along the top/side of the process tank 26. These translation devices may be appropriate robots, which may be controlled by the processor 32 of image analyzer 24, or by a separate control. In one embodiment, the operator may be provided with manual control over the translation devices so that a particular location within the tank 26 can be scrutinized in particular detail.

Alternatively, as shown in FIG. 7, the wafers 1000 themselves may be movable within the tank so that they pass across a stationary transducer 50, or a transducer with limited mobility.

In one exemplary embodiment, the system may simply judge the time it takes for the sound waves emitted by the transducer 50 to travel through the process tank fluid, reflect off the target (e.g. the tank bottom or a broken wafer piece 1000) and return to the transducer 50. If the reflected sound waves return to the transducer 50 more quickly than expected (i.e., faster than a predetermined baseline value), then an obstruction may be judged to exist.

Where an obstruction is detected, the system may emit an audible or visible warning to the user signaling the non-conforming condition. Alternatively, the system may automatically prevent loading of a new set of wafers 1000 in the process tank 26 until the non-confirming condition has been remedied or the warning override.

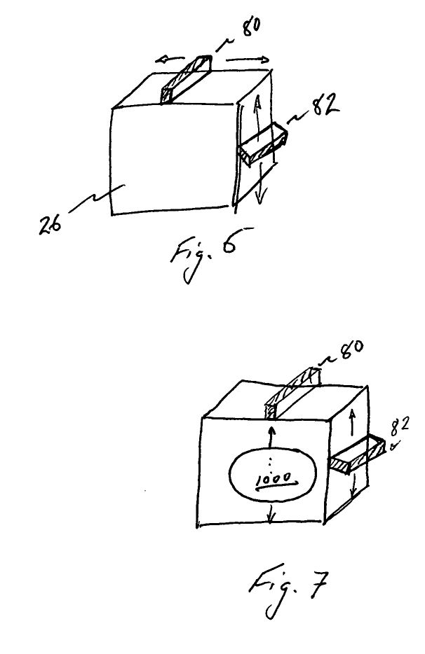

Similarly, the sonar-based process inspection system 200 may be used to detect a mispositioned wafer 1000 within a group of wafers on a lifter simply by operating a top scan of the process tank 26 (using translation device 80 (FIGS. 6 & 7)) and comparing the returned signal to a corresponding previously-recorded baseline signal. Again, any substantial differences between the signals may represent a non-conforming condition, triggering an alarm or other indication to the operator, who may then take appropriate corrective action.

It will be appreciated that this sonar-based system 200 may be used as a separate system, or in combination with the CCD-based image detection system 100. Advantageously, the sonar-based process inspection system 200 may provide the desired imaging of the tank contents even where the process fluid is substantially opaque, and where a CCD camera (such as may be used with system 100) may not provide a desired resolution.

In a further alternative embodiment, a process inspection system 300 may comprise an infrared radiation (IR) detector 60 (e.g. infrared camera) positioned above or adjacent to the process tank 26 to detect a temperature profile in the process tank fluid in order to determine the position of immersed wafers 1000. Any abnormalities in the tank (e.g., broken or mispositioned wafers 1000) may be detected by observing the temperature differences between the wafers 1000, the process fluid, and the wafer lifter, and comparing such images to a baseline IR image.

IR is emitted from an object in direct proportion to the temperature of the object, and so it will be appreciated that for a stable and closed system, that the temperature of all components within the process tank 26 will be the same temperature. However, in a wet bench, different baths (process tanks) are controlled with different temperatures, so the temperature of the wafers 1000 will typically be different from the temperature of a particular process tank when the wafers 1000 are loaded into the tank (e.g., in one segment of a wet bench process, wafers 1000 may be moved in series from a 160° C. H₃PO₄ bath to a 60° C. hot DIW bath to a 20° C. cold DIW bath). Thus, the IR emitted by the wafers 1000 and the process tank fluid will be different when the wafers are initially loaded into the next process tank, and the IR detector 60 may be used to detect these differences in order to determine whether a conforming or non-conforming condition exists in the process tank 26.

The infrared energy can be focused by the IR camera 60 and signals representative of the infrared image can be directed to an image processing system 24 substantially similar to that described in relation to FIGS. 2-4. Sensor electronics and signal processing circuitry within the IR detector 60 and/or image analyzer 24 can translate the data into an image that can be viewed on a standard video monitor. It will be appreciated that this IR-based process system 300 may be used as a separate system, or in combination with the CCD-based image detection system 100. Advantageously, the sonar-based process inspection system 200 may provide the desired imaging of the tank contents even where the process fluid is substantially opaque, and where a CCD camera (such as may be used with system 100) may not provide a desired resolution.

As with the CCD-camera and sonar based image processing systems 100, 200, the IR-based system 300 may incorporate all or some of the same image processing software and analytical algorithms, report-generating features, displays, and user-interactive features including alarms as described for those earlier systems.

As will be appreciated, using image comparison, sound wave comparison, or infrared comparison will provide a detection system that can quickly and automatically identify wafer abnormalities before they result in damage to sensitive and expensive equipment and wafers.

Furthermore, the inventive system represents a marked improvement over the traditional single line detecting mechanism (e.g. one laser beam and one photo detector), providing instead a large-area detecting mechanism. Additionally, by collocating with a moving component, a three-dimensional detecting system can be produced. Thus, one sensor (image, sonar or IR) may be placed on a controlled-movement structure so that the sensor may move with respect to the objective (e.g. wafers on wafer lifter or the process tank). As shown in FIGS. 6 & 7, pair of translating devices 80, 82 can be used to provide both a top scan and a side scan process tank 26. One sensor each can be provided on the translating devices 80, 82 to give a full “volume” scan of the process tank, thus building a 3-D image of the tank contents.

While the foregoing invention has been described with reference to the above embodiments, various modifications and changes can be made without departing from the spirit of the invention. Accordingly, all such modifications and changes are considered to be within the scope and range of equivalents of the appended claims.

1. A system for detecting a wafer, comprising:
a process tank;
an image detection device positioned adjacent said process tank, said imaging device configured to obtain a first set of image data representing an internal portion of said process tank; and
an image processing device connected to said image detection device for receiving said first set of image data from said image detection device;
wherein said image processing device is capable of comparing said first set of image data to said first set of stored data to indicate the presence of a first conforming condition when the difference between the first set of image data and the first set of stored data is within a first predetermined range, and to indicate the presence of a first nonconforming condition when the difference between the first set of image data and the first set of stored data is outside said first predetermined range.

2. The system of claim 1, wherein said process tank comprises a process fluid for processing semiconductor wafers immersed in said fluid, and said first conforming condition corresponds to a configuration of said process tank prior to immersing said semiconductor wafers in said fluid.

3. The system of claim 2, wherein said first conforming condition corresponds to an image of said process tank with said process fluid, and said first nonconforming condition corresponds to an image of said process tank with said process fluid and at least one broken wafer in said process tank.

4. The system of claim 3, wherein said image detection device comprises one of a charge coupled device (CCD), an active sonar transducer, and an infrared camera.

5. The system of claim 1, said system further comprising a user interface for indicating the presence of a nonconforming condition, said user interface comprising a video display on which said first set of image data is displayable to an operator.

6. The system of claim 1, said system further comprising a wafer lifter supporting a plurality of wafers, and said image detection device further being positioned and configured to transmit a second set of image data representing at least a portion of said wafer lifter and said plurality of wafers, wherein said image processing device is configured to receive said second set of image data and to compare said second set of image data with a second set of stored data to indicate the presence of a second conforming condition when the difference between the second set of image data and the second set of stored data is within a second predetermined range, and to indicate the presence of a second nonconforming condition when the difference between the second set of image data and the second set of stored data is outside said second first predetermined range.

7. The system of claim 6, wherein said second nonconforming condition comprises the presence of a broken or mispositioned wafer on said wafer lifter.

8. The system of claim 1, further comprising a translation robot for moving the image detection device with respect to said process tank to allow the image detection device to perform a scan of the process tank.

9. The system of claim 1, further comprising a sonar transmitting and detection device positioned adjacent said process tank, said sonar detection device configured to transmit sound waves within a fluid disposed within said process tank, said sonar transmitting and detection device being further configured to receive sound waves reflected from said process tank and to transmit a first set of reflected sound data; said system further comprising a sound data processing device connected to said sonar detection device for receiving said first set of reflected sound data from said sonar detection device;
wherein said sound data processing device is capable of comparing said first set of reflected sound data with a first set of stored sound data to indicate the presence of a first conforming condition when the difference between the first set of reflected sound data and the first set of stored reflected sound data falls within a third predetermined range, and to indicate the presence of a first nonconforming condition when the difference between the first set of reflected sound data and the first set of stored reflected sound data falls outside of said third predetermined range.

10. A system for detecting a wafer, comprising:
an image detection device for receiving a first image of an internal portion of a semiconductor process tank, said imaging device configured to transmit a first set of image data representing said internal portion of said semiconductor process tank; and
an image processing device connected to said image detection device for receiving said first set of image data from said image detection device;
wherein said image processing device is capable of comparing said first set of image data with said first set of stored data to indicate the presence of a first conforming condition when the first set of image data substantially conforms to said first set of stored data, and to indicate the presence of a first nonconforming condition when the image data does not substantially conform to said first set of stored data.

11. The system of claim 10, wherein said process tank comprises a fluid for processing semiconductor wafers immersed therein, and said first conforming condition corresponds to a configuration of said process tank prior to immersing said semiconductor wafers in said fluid.

12. The system of claim 11, wherein said first nonconforming condition comprises the presence of a broken wafer in said process tank.

13. The system of claim 12, wherein said image detection device comprises a charge coupled device (CCD), said system further comprising a video display on which said first set of image data is displayable to an operator.

14. The system of claim 10, said system further comprising a user interface for indicating the presence of a nonconforming condition, said user interface comprising an alarm.

15. The system of claim 10, said system further comprising a wafer lifter supporting a plurality of wafers, and said image detection device further being positioned and configured to transmit a second set of image data representing at least a portion of said wafer lifter and said plurality of wafers, wherein said image processing device is configured to receive said second set of image data and compare said second set of image data with a second set of stored data to indicate the presence of a second conforming condition when the second set of image data substantially conforms to said second set of stored data, and to indicate the presence of a second nonconforming condition when the second set of image data does not substantially conform to said second set of stored data.

16. The system of claim 10, wherein said second nonconforming condition comprises the presence of a broken or mispositioned wafer on said wafer lifter.

17. The system of claim 10, further comprising a translation robot for moving the image detection device with respect to said process tank to allow the image detection device to perform a scan of the process tank.

18. The system of claim 10, further comprising a sonar transmitting and detection device positioned adjacent said process tank, said sonar detection device configured to transmit sound waves within a fluid disposed within said process tank, said sonar detection device being further configured to receive sound waves reflected from said process tank and to transmit a first set of reflected sound data; said system further comprising a sound data processing device connected to said sonar detection device for receiving said first set of reflected sound data from said sonar detection device;
wherein said sound data processing device is capable of comparing said first set of reflected sound data with a first set of stored sound data to indicate the presence of a first conforming condition when the difference between the first set of reflected sound data and the first set of stored reflected sound data is within a third predetermined range, and to indicate the presence of a first nonconforming condition when the difference between the first set of reflected sound data and the first set of stored reflected sound data is outside of said third predetermined range.

19. A method for detecting a semiconductor wafer, comprising:
receiving a first image representing an internal portion of a semiconductor process tank;
digitizing said first image and providing a first signal to an image analyzer, said first signal comprising a first set of data representative of said first image;
displaying said first image on a display device for viewing by an operator;
comparing said first set of data to a first set of stored data to obtain a first difference between said first set of data and said first set of stored data, wherein said first set of stored data represents a conforming condition of said semiconductor process tank; and
sending a second signal when said first difference is not within a first predetermined range, thus representing a non-conforming condition of said semiconductor process tank;
wherein said second signal comprises an alarm signal for communicating said non-conforming condition to said operator.
